(19) United States
(12) Patent Application Publication
(10) Pub. No.: US 2024/0217657 A1
(43) Pub. Date: Jul. 4, 2024

(54) AERIAL VEHICLE FOR TRANSPORTING A PLURALITY OF ARTICLES

(71) Applicant: Wingcopter GmbH, Weiterstadt (DE)

(72) Inventor: Jonathan HESSELBARTH, Darmstadt (DE)

(73) Assignee: Wingcopter GmbH, Weiterstadt (DE)

(21) Appl. No.: 18/557,129

(22) PCT Filed: Apr. 26, 2022
(86) PCT No.: PCT/EP2022/061080

§ 371 Date: Jan. 25, 2024

(30) Foreign Application Priority Data
Apr. 26, 2021 (DE) 10 2021 110 651.6

(51) Int. Cl. B64D 1/12; B64D 1/22

(52) U.S. Cl. CPC B64D 1/12; B64D 1/22

(57) ABSTRACT

An aircraft (1) includes a transporting device (2) for receiving and transporting a plurality of articles. The transporting device (2) includes a plurality of receiving devices (4). A respective article (3) can be releasably arranged on a receiving device (4). The receiving device (4) can be moved into a transporting position and into a release position. In a transporting position of the receiving device (4), the article (3) has been secured on the receiving device (4) and, in a release position, the article (3) has been separated from the receiving device (4). In the transporting position of the receiving device (4), the articles (3) are arranged on an underside (5) of the aircraft (1) and one behind the other in a horizontal direction of flight (6) of the aircraft (1).

### CROSS-REFERENCE TO RELATED APPLICATION

This application is a national stage application, filed under 35 U.S.C. § 371, of International Patent Application PCT/EP2022/061080, filed on Apr. 26, 2022, which claims the benefit of German Patent Application DE 10 2021 110 651.6, filed on Apr. 26, 2021.

### BACKGROUND

Vertical takeoff aircraft, for example so-called quadcopters, are known as aircraft for transporting general articles. A quadcopter is an aircraft in which four rotors or propellers arranged in a plane and acting vertically downwards are used to generate lift. The propulsion of the quadcopter is generated by tilting the rotor plane. These aircraft can transport a certain payload over a certain distance, depending on their drive power. Depending on the drive power and the payload received, the range is limited by the available battery capacity.

Prior art aircraft are known that are equipped with a cable winch arranged on the outside of the aircraft, which makes it possible to receive articles. The loading or unloading of the aircraft is typically achieved by lowering the winch to the loading or unloading location and securing the item by means of a receiving device attached to the end of the cable winch. The receiving device can be configured, for example, as a hook, an eye or a magnet. The fastening of the article to the receiving device of the cable winch is usually achieved in a manual step by an operator standing on the ground. The article is then pulled up by the winch to a position close to the underside of the aircraft, where it remains during flight.

Prior art aircraft are configured to transport only one article. As a rule, only one cable winch is provided on which an article can be loaded or unloaded during the loading or unloading process. With prior art aircraft, only one article can be delivered at a time, such that the aircraft must return to the takeoff point to reload. This severely restricts economical flight operations of articles with known aircraft.

### SUMMARY

The disclosure relates to an aircraft having a transporting device for receiving and transporting a plurality of article. The transporting device comprises a plurality of receiving devices. A respective article can be releasably arranged on a receiving device. The receiving device can be moved into a transporting position and into a release position, wherein in a transporting position of the receiving device, the article is secured on the receiving device and, in a release position, the article is separated from the receiving device.

It is an object of the present disclosure to provide an aircraft for transporting and delivering a plurality of articles, wherein the aircraft has aerodynamic properties.

This object is achieved in that the articles are arranged one behind the other in the transporting position of the receiving device on an underside of the aircraft and in a horizontal direction of flight of the aircraft. Due to the arrangement of the articles one behind the other, a total surface area formed by the end faces of the articles pointing in the horizontal direction of flight and flowing against the horizontal direction of flight can be particularly small. Thus, air resistance caused by the articles and arising during the horizontal flying position is particularly low. The articles are advantageously aligned in such a way that the end face of the articles points in the horizontal direction of flight, which has a particularly small surface area. Thus, the air resistance in the horizontal direction of flight can be particularly low, such that a particularly energy-saving flight operation can take place and a long flight duration and thus a long range of the aircraft is available. Due to the arrangement of the plurality of articles one behind the other, a particularly efficient delivery operation for the articles can be carried out by means of the aircraft.

It is provided that unloading of the aircraft is effected by releasing the articles detachably arranged on the receiving device in a release position of the receiving device and subsequently dropping down towards the ground under the force of gravity. To do this, the aircraft is first brought close to the ground and then the unloading process is started. Alternatively, it is also provided that the articles can be unloaded from a higher flight altitude. For this purpose, the article has a drop braking device or an impact protection device, which reduces the drop speed and the impact when the article hits the ground. This allows for a particularly fast unloading process of the aircraft.

In order to achieve a particularly low air resistance of the aircraft and the articles during flight, in an advantageous implementation it is provided that the parts are arranged in the transporting position of the receiving device along an arrangement axis oriented parallel to the horizontal direction of flight of the aircraft. Thus, the total area oriented in the horizontal direction of flight and formed from individual end faces is particularly small. This means that particularly long flight operations can be carried out.

In order to achieve a particularly low flow resistance, in an advantageous embodiment it is provided that the plurality of articles with different surface areas of the end faces is arranged one behind the other in such a way that a sequence of the articles in an inflow direction opposite to the horizontal direction of flight is selected in such a way that the articles with ascending surface area of the end face are arranged one behind the other. This means that the cargo with the smallest end face in the horizontal direction of flight is arranged at the front, so that the flow resistance generated by the flow during flight is particularly low. This enables the aircraft to fly for a particularly long time.

In an advantageous embodiment of the aircraft, it is provided that the article is configured as a transport container. Due to a predetermined shape of the transport container, the flow resistance generated by the articles during flight operation can be predicted particularly well. For example, small and flow-impaired articles can be received and enclosed within the transport container. The outer shape of the transport container is configured in such a way that the end faces of the transport container pointing in the horizontal direction of flight are streamlined and particularly aerodynamic, such that any flow resistance generated during the flight movement is low. This allows the aircraft to fly for a particularly long time.

In order to maintain the arrangement of the transport containers one behind the other and in particular the arrangement of the transport containers one behind the other along the arrangement axis also during the flight movement, in an advantageous implementation it is provided that the transport containers are in contact with each other in the transporting position. For this purpose, the respective adjacent transport containers optionally have recesses and/or protrusions that respectively engage with the recesses or protrusions of the respective adjacent transport containers, such that a relative position of two adjacent transport containers to each other is maintained.

In order to provide a particularly efficient loading or unloading process, in an advantageous implementation, it is provided that the transporting device comprises at least two cable winches. With the cable winch, an article fixed to the cable winch can be lowered particularly easily from the aircraft to the unloading location on the ground and unloaded there. Likewise, a new article can be fixed to the cable winch very easily and quickly near the ground and pulled up to the aircraft. Thus, a particularly fast unloading process is possible, such that a particularly efficient flight operation of the aircraft is possible. Advantageously, one article is fixed to each cable winch such that each article can be lowered to the unloading location independently of the other articles.

In order to keep the flow resistance generated by the aircraft during flight operation particularly low, it is provided in an embodiment of the aircraft that the at least two cable winches are arranged within an aircraft fuselage. Thus, the components of the cable winch that are not adapted to the flow and generate a high flow resistance are protected from the flow generated during flight operation.

In order to be able to advantageously arrange the articles in the transporting position of the receiving device along the arrangement axis, it is provided in an advantageous embodiment that a plurality of cable winches is arranged one behind the other in the horizontal direction of flight in the aircraft fuselage.

Further advantageous embodiments of the aircraft are explained with reference to exemplary embodiments shown in the drawings. In the drawings:

### BRIEF DESCRIPTION OF THE DRAWINGS

FIG. 1 shows a schematic representation of the aircraft in a perspective view,

FIG. 2 shows a schematic representation of the aircraft in a side view, and

FIG. 3 shows a schematic representation of the aircraft in a front view.

### DETAILED DESCRIPTION

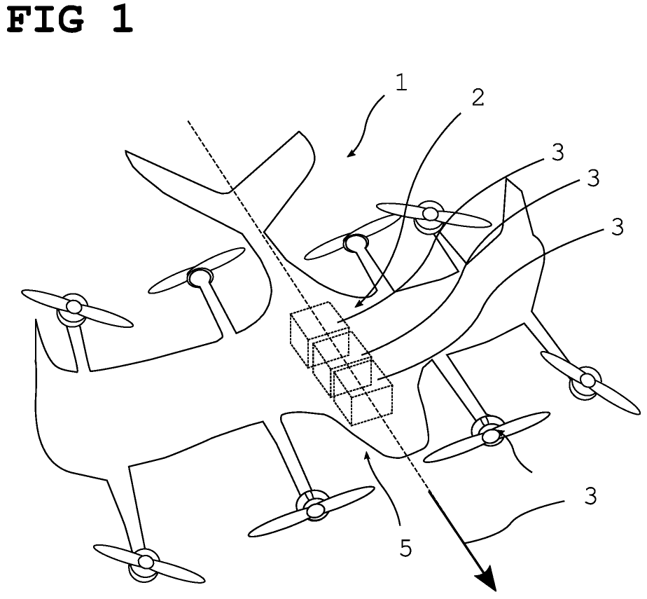

FIG. 1 shows a schematic representation of an aircraft 1 with a transporting device 2 for receiving and transporting three articles 3. The transporting device 2 comprises a plurality of holding devices 4 (not shown in FIG. 1). An article 3 is detachably attached to each of the holding devices 4. The receiving device 4 can be brought into a transporting position and into a release position. In a transporting position of the receiving device 4, the article 3 has been secured on the receiving device 4 and, in a release position, the article 3 has been separated from the receiving device. In the transporting position of the receiving device 4, the articles 3 are arranged on an underside 5 of the aircraft 1 and one behind the other in a horizontal direction of flight 6 of the aircraft 1.

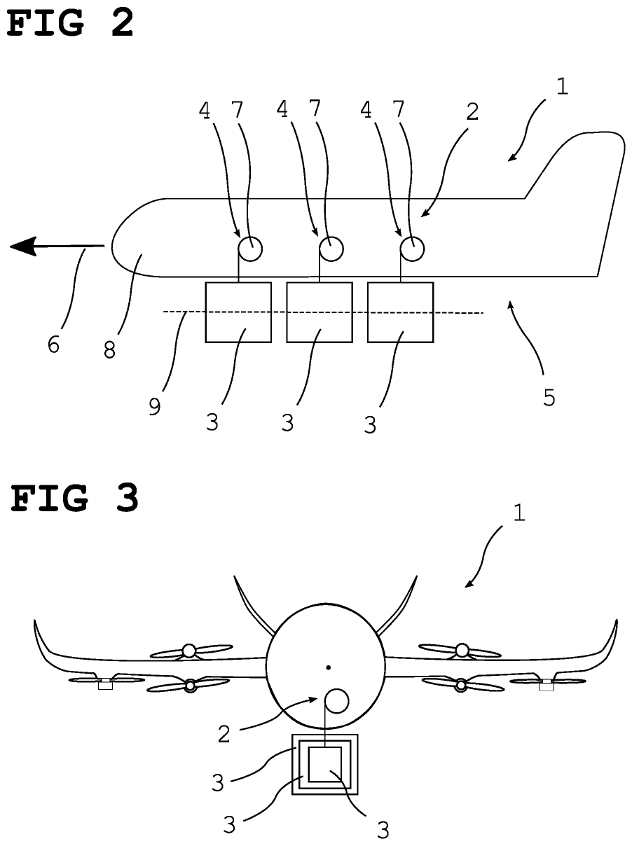

FIG. 2 shows a schematic representation of the aircraft 1 in a side view. The transport device 2 comprises three cable winches 7 arranged one behind the other in the horizontal direction of flight 6 within an aircraft fuselage 8. An article 3 is fixed to each cable winch 7, wherein the articles 3 are arranged along an arrangement axis 9 oriented parallel to the horizontal direction of flight 6 of the aircraft 1 on an underside 5 of the aircraft 1.

FIG. 3 shows a schematic representation of the aircraft 1 in a front view. The transporting device 2 is shown in a transporting position. The three articles 3 have different dimensions from each other. The three articles 3 are arranged one behind the other in such a way that a sequence of the articles 3 in an inflow direction opposite to the horizontal direction of flight 6 is selected in such a way that the articles 3 with ascending surface area of the end face are arranged one behind the other.

1.-8. (canceled)

9. An aircraft (1), comprising:
a transporting device (2) for receiving and transporting a plurality of articles,
wherein the transporting device (2) comprises a plurality of receiving devices (4),
wherein the articles (3) can be releasably arranged on the receiving devices (4),
wherein the receiving devices (4) can be moved into a transporting position and into a release position,
wherein in a transporting position of the receiving devices (4), the articles (3) are secured on the receiving devices (4) and, in a release position, the articles (3) are separated from the receiving devices (4),
wherein in the transporting position of the receiving devices (4), the articles (3) are arranged on an underside (5) of the aircraft (1) one behind another in a horizontal direction of flight (6) of the aircraft (1).

10. The aircraft (1) according to claim 9,
wherein in the transporting position of the receiving devices (4) the articles (3) are arranged along an arrangement axis (9) oriented parallel to the horizontal direction of flight (6) of the aircraft (1).

11. The aircraft (1) according to claim 9,
wherein the articles (3) have different surface areas of their respective end faces and are arranged one behind another in such a way that a sequence of the plurality of articles (3) in an inflow direction opposite to the horizontal direction of flight (6) is selected in such a way that the articles (3) are arranged one behind another with ascending surface areas of the respective end faces.

12. The aircraft (1) according to claim 9,
wherein the articles (3) are configured as a transport containers.

13. The aircraft (1) according to claim 12,
wherein the transport containers are in contact with each other in the transporting position.

14. The aircraft (1) according to claim 9,
wherein the transporting device (2) comprises at least two cable winches (7).

15. The aircraft (1) according to claim 14,
wherein the at least two cable winches (7) are arranged within an aircraft fuselage.

16. The aircraft (1) according to claim 15,
wherein the at least two cable winches (7) are arranged one behind another in the aircraft fuselage (8) in the horizontal direction of flight (6).
